(19) United States
(12) Patent Application Publication
(10) Pub. No.: US 2019/0143741 A1
(43) Pub. Date: May 16, 2019

(54) WRITING EQUIPMENT WITH A SCALE ATTACHED

(71) Applicants: Masahiro Nakano, Kanagawa Pref (JP); Kako Fukuda, Kanagawa Pref (JP); Kenta Domeki, Ibaraki Pref (JP); Hiroki Koyama, Tokyo (JP); Ayano Fujii, Tokyo (JP); Yosuke Saito, Kanagawa Pref (JP); Shun Ohyama, Kanagawa Pref (JP); Ayumi Watanabe, Tokyo (JP); Shotaro Nishiyone, Saitama Pref (JP)

(72) Inventors: Masahiro Nakano, Kanagawa Pref (JP); Kako Fukuda, Kanagawa Pref (JP); Kenta Domeki, Ibaraki Pref (JP); Hiroki Koyama, Tokyo (JP); Ayano Fujii, Tokyo (JP); Yosuke Saito, Kanagawa Pref (JP); Shun Ohyama, Kanagawa Pref (JP); Ayumi Watanabe, Tokyo (JP); Shotaro Nishiyone, Saitama Pref (JP)

(21) Appl. No.: 16/244,140

(22) Filed: Jan. 10, 2019

(51) Int. Cl. B43K 29/08; B43K 7/00; B43K 7/12; B43L 7/00

(52) U.S. Cl. CPC B43K 29/08; B43K 7/005; B43K 25/02; B43L 7/007; B43K 7/12

(57) ABSTRACT

Writing equipment includes a cylinder-shaped body having a lead and a lead tank, and an arch-shaped scale on which scale marks are printed, wherein the scale is coupled with the body detachably, and wherein the scale is formed with the particular angle, which is same as that of a curve of the cylinder-shaped body.

### BACKGROUND OF THE INVENTION

### 1. Field of the Invention

This invention has been made by the members of MIMURA Seminar, College of Law, Nihon, Univ. as a team. The present invention relates to writing equipment, specifically to a writing tool which measures length and draws a straight line without an independent scale.

### 2. Description of the Related Art

Conventionally, a rectangular-shaped scale or a curve-shaped scale is used when a straight line is drawn or the length is measured in a school or the construction site.

According to the conventional method, in order to draw a straight line, or in order to measure the length of the line while using a pen, a scale, which is independent to the pen, should be used. However, a lot of writing tools, such as a mechanical pencil, its lead, ballpoint pens, an eraser, and others are generally contained in a pencil case. As a result, the pencil case may be bulged. Generally, the bulging pencil case may not be suitable to carry.

Further, a scale having 25 cm long is not necessary for measuring the length of a few cm, and such an elongate scale occupies the space inside the pencil case.

An objective of the present invention is to resolve the above-described problem and to provide writing equipment having a scale, which is a debatable from the body. The objective is achieved by writing equipment including a cylinder-shaped body having a lead and a lead tank, and an arch-shaped scale on which scale marks are printed, wherein the scale is coupled with the body detachably, and wherein the scale is formed with the particular angle, which is same as that of a curve of the cylinder-shaped body.

### BRIEF DESCRIPTION OF THE DRAWINGS

The invention will be more particularly described with reference to the accompanying drawings, in which

FIG. 1 is a side view of a pen having a scale, according to the first embodiment of the invention,

FIG. 2 is an enlarged perspective view of an area of the main body 10 starting from a hand grip 50 and ending to a pen end,

FIG. 3 is a cross-sectional view with respect to the arrows A to A′ shown in FIG. 1.

FIG. 4 is an enlarged perspective view of a pen having a scale, according give the second embodiment of the invention, and,

FIG. 5 is a cross-sectional view with respect to the arrows B to B′ shown in FIG. 4.

### DETAILED DESCRIPTION OF THE PREFERRED EMBODIMENTS

### The First Embodiment

The first preferred embodiment of the invention as to a writing equipment with scale attached is explained together with drawings as follows. In each drawing, the same reference numbers designate the same or similar components through all embodiments.

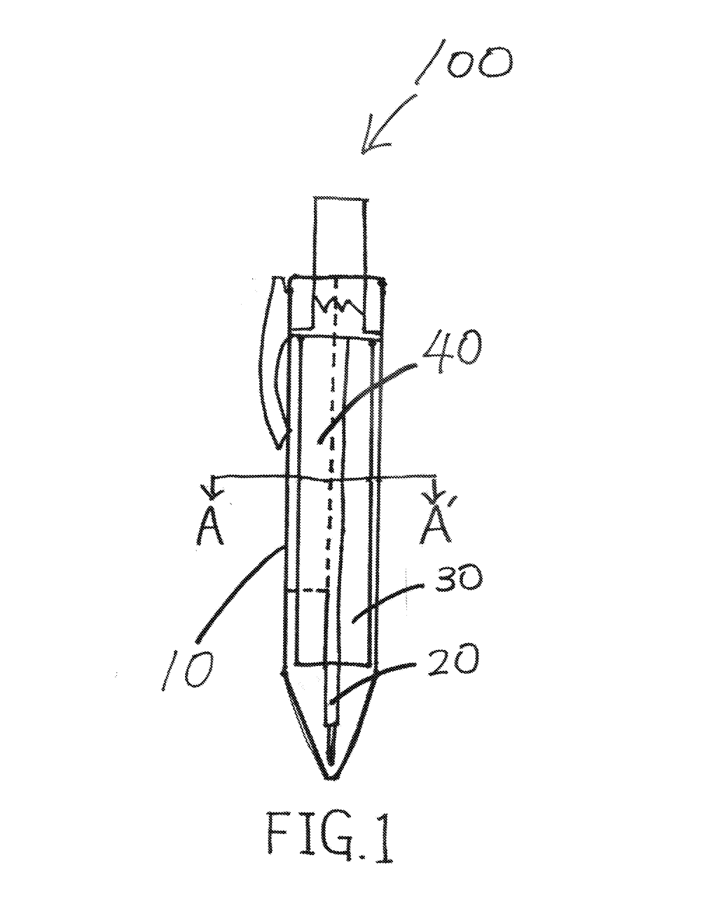

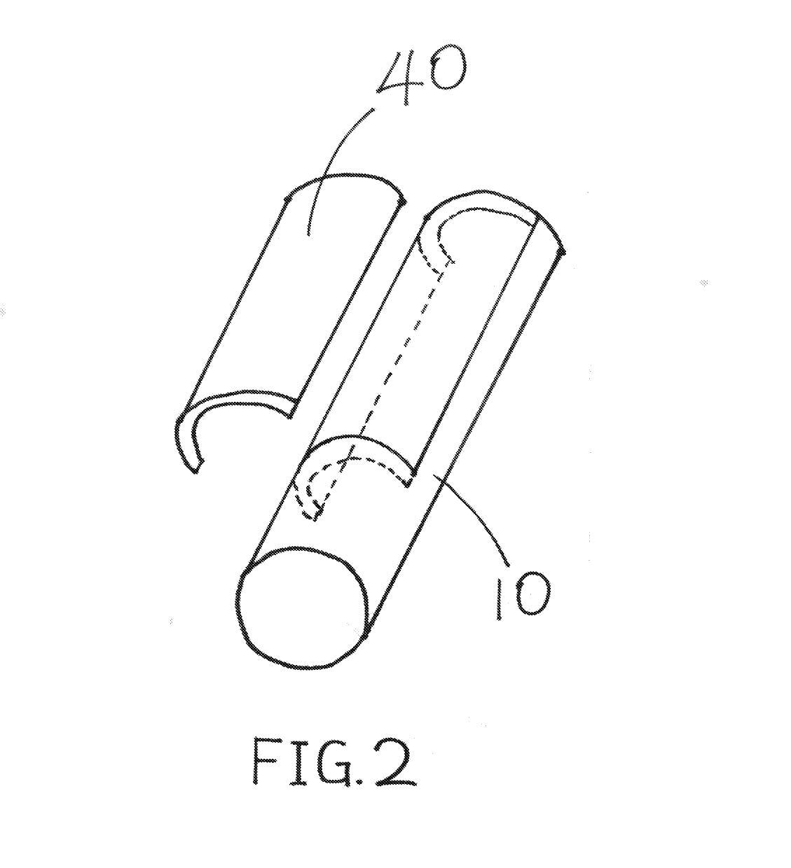

FIG. 1 shows a side view of a writing equipment with a scale attached of the present invention. FIG. 2 shows an enlarged view of an area where the scale is formed.

As shown in FIG. 1, the writing equipment 100 of the first embodiment includes a cylinder-shaped main body 10, a lead 20 stored in the main body 10, a lead tank 30, a scale 40, which can be detachable from the main body 10, and a hand grip 50, which is formed on the surface of the main body 10 adjacent to one end of the writing equipment 100.

As shown in FIG. 1 and FIG. 2, the detachable scale 40 is formed in arch-shaped, and is formed as a part of the main body 10 in general use. Therefore, the arch shape of the detachable scale 40 is formed with the particular angle, which is same as that of a curve of the cylinder-shaped main body 10. Under general use, since the detachable scale 40 it is integrated with the main body 10 when it is used as a pen, it does not bring any discomfort for using.

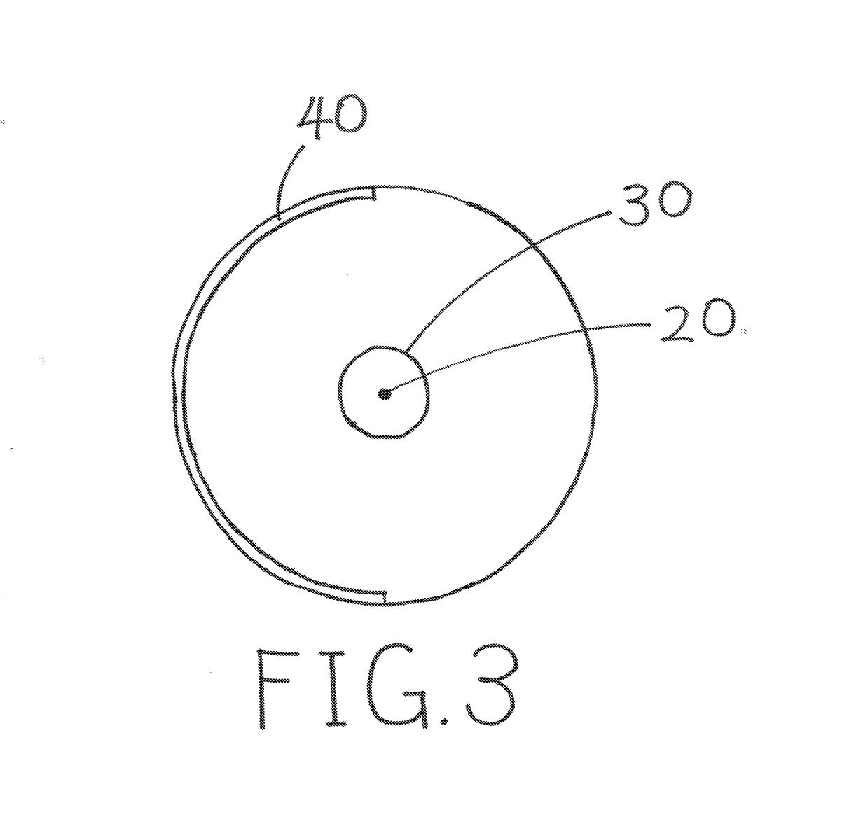

As shown in FIG. 3, the detachable scale 40 has an arc length, which equals to half of the length of the outer periphery of the main body 10. A scale marks are printed on the surface of the detachable scale 40. The detachable scale 40 is preferably formed about 10 cm in length. Of cause, it is possible to form the detachable scale 40 with the length, which equals to the length starting from the location of a hand grip 50 adjacent to the one end of the main body 10 and ending to the location of a pen end adjacent to the other end of the main body 10 so that the maximum scale length can be secured. The detachable scale 40 is formed of a magnet, and the main body 10 is formed of a metal, such as iron, which is attracted to the detachable scale 40 by magnetic force. If the entire body 10 is formed of iron, it becomes heavy. Thus, it is possible to form the main body with plastic and to put the iron powder or the nickel powder only in an area of the main body 40 where the detachable scale 4 is integrated. Using the material as described above, it is possible to integrate the removal scale 40 and the main body 10 by utilizing the magnetic force. While the main body is formed of plastic in the embodiment above, it is also possible to form the main body with light metal having the iron powder or nickel powder in the area in order to establish the scale 40 and the body 10 in unity. As a result of such combination, it is also possible to form a stylish pen. Moreover, it is possible that the main body 10 is formed of magnet, and a removable scale is formed of a metal.

According to the first embodiment of the invention, although the invention is applied to the pen 100, it is possible to apply the invention to other writing equipment,such as felt pen, pen made from a bird's feather, pencil,ball-point pen, mechanical pencil.

### The Second Embodiment

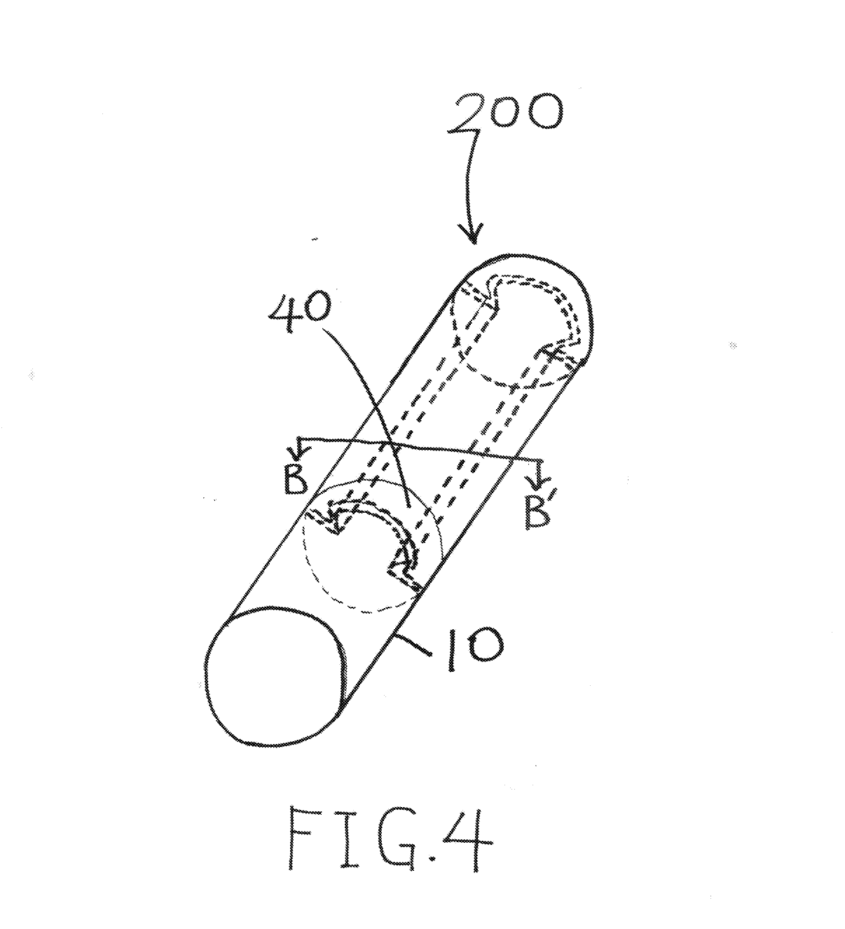

FIG. 4 is an enlarged-prospective view of a pen having a scale, according give the second embodiment of the invention.

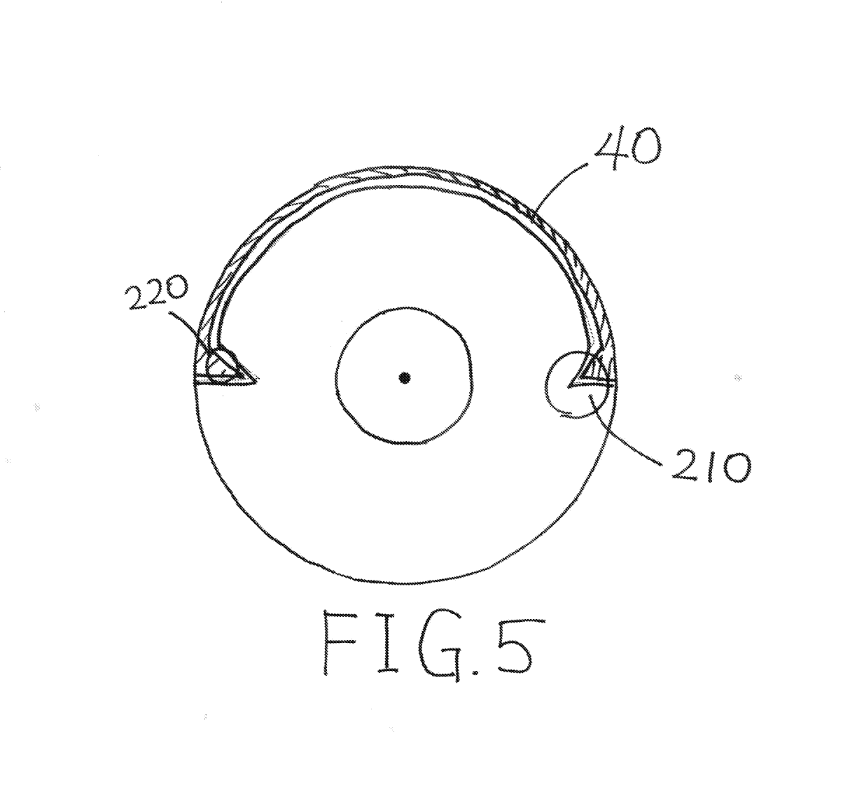

The writing equipment 200 includes a cylinder-shaped main body 10, a lead 20 stored in the main body 10, a lead tank 30, and a scale 40 which can be detachable from main body 10. The difference between the first embodiment and the second embodiment is as follows. While the scale 40 is attracted to the main body by magnetic force in the first embodiment, a convex part 220 of the scale is held by a concave part 210 of the main body 40. As shown in FIG. 5. Thus, in order to detach the scale 40 from the main body 10, it is necessary to by slide the scale 40. According to the second embodiment, the scale is not held by the magnetic force, any material can be used for of the main body 10 and the scale 40, such as plastic, aluminum and so on.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention.

We claim:

1. Writing equipment, comprising:
a cylinder-shaped body having a lead and a lead tank, and
an arch-shaped scale on which scale marks are printed, wherein the scale is coupled with the body detachably, and wherein the scale is formed with the particular angle, which is same as that of a curve of the cylinder-shaped body,
wherein the arch-shape of the detachable scale is formed with the same particular angle, which is same as that of a curve of the cylinder-shaped body.

2. Writing equipment as claimed in claim 1, further comprising a hand grip being formed on the surface of the body, and being adjacent to one end of the body, wherein the scale has length, which equals to the length starting from the location of a hand grip 50 and ending to the location of a pen end adjacent to the other end of the body.

3. Writing equipment as claimed in claim 1, wherein the scale has arc length, which equals to half of the length of the outer periphery of the body.

4. Writing equipment as claimed in claim 1, wherein the outer surface of the body is made of material, which can be attracted to a magnet by magnetic force, and wherein the scale is made of the magnet.

5. Writing equipment as claimed in claim 4, wherein the outer surface of the body is formed with one of nickel, cobalt and iron.

6. Writing equipment as claimed in claim 1, wherein the scale is made of material, which can be attracted to a magnet by magnetic force, and wherein the body is made of the magnet.

7. Writing equipment as claimed in claim 6, wherein the scale is formed one of nickel, cobalt and iron.

8. Writing equipment as claimed in claim 1, wherein the scale has a convex part and the body has concave part, which is couple with the convex part, whereby the scale is held by the body.
